(19) United States
(12) Patent Application Publication
(10) Pub. No.: US 2005/0216362 A1
(43) Pub. Date: Sep. 29, 2005

(54) Method of and system for providing an online marketplace having global reach and local focus

(76) Inventors: Rajesh Navar, Los Altos Hills, CA (US); Sunil Palacherla, San Jose, CA (US); Jeffrey Artabane, Boston, MA (US)

Correspondence Address: INNOVATION MANAGEMENT SCIENCES, P. O. BOX 1169, LOS ALTOS, CA, 94023-1169, US

(21) Appl. No.: 10/993,139

(22) Filed: Nov. 18, 2004

Related U.S. Application Data
(63) Continuation-in-part of application No. 10/868,530, filed on Jun. 15, 2004.
(60) Provisional application No. 60/528,133, filed on Dec. 9, 2003.

(51) Int. Cl. G06F 17/60

(52) U.S. Cl. 705/26

(57) ABSTRACT

An online marketplace having global reach and local focus is described. A Web-site including an item catalog that is searchable and browsable is provided. When a user browses or searches the Web-site, local items are presented more prominently and the non-local items are presented less prominently, perhaps in clearly differentiated sections and/or perhaps by manipulating the order in which the items are presented. According to one embodiment, the invention promotes local transactions because items local to the buyers would have a higher visibility than non-local items. At the same time, the invention enables the sellers to showcase their items to a global audience, and gives flexibility to the buyer to purchase items from a non-local source.

### RELATED APPLICATIONS

The present application: (1) claims priority to co-pending U.S. Provisional Patent Application bearing Ser. No. 60/528,133, which was filed on Dec. 9, 2003, and which is incorporated herein by reference; and (2) is a continuation-in-part of co-pending U.S. Non-Provisional patent application bearing Ser. No. 10/868,530, which was filed on Jun. 15, 2004, and which is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD OF THE INVENTION

The present invention relates generally to a method of and system for providing an online marketplace having global reach and local focus.

### BACKGROUND OF THE INVENTION

The Internet is a worldwide system of connected computer networks. The Internet enables computers of all kinds to communicate directly, as if they were part of one giant seamless global computing machine. The Internet is currently configured to join together large commercial communications services as well as thousands of university, government and corporate computer networks and other computers. The World Wide Web is a collection of Web pages and Web-sites that are accessible via the Internet by means of various communication protocols (e.g., HTTP, FTP). Communications over the World Wide Web may be interactive and is referred to as online.

There are currently Web-sites that allow users to post items for sale. A well known example of such Web-sites is ebay.com. An advantage of these Web-sites is their global reach. A posting on ebay.com, for instance, can be exposed to virtually any potential buyers who have Internet access. It is believed that, when the number of potential buyers is large, the sellers may be able to obtain good prices for their items.

Nevertheless, not every item is suitable for sale via online auction sites such as eBay.com. In general, items that have a low value-to-weight ratio (e.g., used mattresses) and bulky items generally are not suitable for shipping cross country and thus they are not suitable for sale online. Many other items are unsuitable because the items themselves are inherently unshippable (e.g., services). Some items are so expensive that few people would consider purchasing online without first inspecting the items in person.

There are currently a few online services that allow sellers to connect to buyers at a local level. Those services typically involve online message boards on which sellers can post classified advertisements for items/services they offer and on which buyers can browse and search these advertisements. Those online message boards typically organize the classified advertisements first in terms of geographical location and then by category of the goods/services offered. Each geographical area has its own message board for posting classified advertisements, and item browsing/searching is limited to each individual message board. However, since postings are posted on geographically-specific message boards, buyers looking for items on one message board may not see items posted on other message boards. Accordingly, the number of potential viewers of the posted items may be lower, and prices for similar items may vary greatly from one message board to another.

Heretofore, there has not been an online marketplace that has both global reach and local focus to promote geographically-specific and non-geographically specific transactions at the same time.

### SUMMARY OF THE INVENTION

In one aspect, the invention provides an online marketplace that promotes transactions between users located within their vicinity over transactions between remote users. In one embodiment of the invention, the online marketplace comprises an online database on which users may post items for sale and on which users may browse or search the posted items. In one embodiment, users browsing or searching the online database would be presented with postings that are relevant to them. More particularly, postings that are more geographically relevant to the users would be presented more prominently than postings that are less geographically relevant. For instance, a user may be first presented with the most geographically relevant postings first, and only after the user has seen these postings would he be able to view less geographically relevant postings.

According to one embodiment of the invention, each item may be associated with a community (e.g., a geographical location), and each user browsing or searching the online database may specify a community to which they belong. Items associated with the user's community, as well as items associated with communities near the user's community would be considered geographically relevant or “local.” Items associated with communities that are not near the user's community, however, would be considered less geographically relevant or “non-local.” In other words, non-local items may be presented less prominently than local items, for instance by listing local items before non-local items. In another instance, local items and non-local items may be presented in different sections of a Web-page, or in different font sizes, etc. In this way, local items may get more visibility than non-local items.

According to another embodiment of the invention, items may be classified as “shippable” and “non-shippable” items. In this embodiment, a user searching or browsing the online database would be able to view local items and non-local items that are shippable. Non-shippable items that are non-local with respect to the user, however, would not be presented.

In another aspect, the invention may be used to target a specific group of people with similar needs who associate themselves with something that is common to all within the group. In one embodiment, when a user posts an item on the online database, he may designate the item viewable by those who belong to a certain group, such as students and faculties of colleges and universities. When viewed by members of the targeted group, items designated as such may be presented more prominently than other items. In this way, the online marketplace of the invention provides an efficient and effective way to target a specific group of users.

In another aspect, the invention provides an online marketplace through which users connect and make transactions. Implementing the marketplace does not require taking responsibility for any of the products or services listed in a community or the transaction, delivery, or exchange of the products or services. Rather, the market place acts as a broker or intermediary to facilitate transactions between users. The online marketplace of the invention may provide optional tools to facilitate communication or transactions between users, such as electronic mail, online messaging, online chat, online discussion boards, and the like. In addition, the online market place of the invention may provide a feedback system to encourage members to provide feedback regarding transactions with other members. The online marketplace of the invention may also provide an Internet-based forum for auctions, where “local” items are presented to bidders more prominently than “non-local” items such that bidding of “local” items is promoted.

### BRIEF DESCRIPTION OF THE DRAWINGS

The invention will now be described with reference to the accompanying drawings which illustrate an example embodiment of the invention. Throughout the description, similar reference names may be used to identify similar elements.

FIG. 1 depicts a framework for using Internet technology to facilitate localized commerce in accordance with an embodiment of the invention.

FIG. 2 depicts a server for use in the framework of FIG. 1, in accordance with an embodiment of the invention.

FIGS. 3A-3C depict example database records for use in the framework of FIG. 1, in accordance with an embodiment of the invention.

FIGS. 4A-4D depict flowcharts of processes carried out by software modules of the server of FIG. 2, in accordance with embodiments of the invention.

FIGS. 5A-5G depict screenshots from an example online marketplace according to an embodiment of the invention.

### DETAILED DESCRIPTION OF PREFERRED EMBODIMENTS

Various features of the invention, including specific implementations thereof, will now be described. Throughout the description, the term “item” will be used to refer generally to a saleable unit, whether a physical or digital object, a service, a transferable right, a license, or data that may have a range of attributes. The term “item” will also be used to refer generally to both something that may be purchased, and its record or description within a database (e.g., a mobile phone's description within a database). The term “item” may also be used to refer generally to an advertisement, such as an advertisement for goods/service offered, goods/service wanted, a job listing, a job wanted advertisement, and a personal advertisement. The term “product” is used in the same manner.

Throughout the description, the term “local items” may refer to items that are geographically relevant to a user. For instance, an item that is available within a certain distance from the user's location, or those designated as such by the seller, would be considered a local item. “Local items” may also refer to items that are available within the buyer's “community,” or those that are available within a certain distance from the buyer's “community.” The term “non-local items” may refer to items that are available outside of a certain distance from the buyer's location, or those designated as such by the seller. “Non-local items” may also refer to items that are not geographically relevant to the user. For instance, items that are available from sellers located outside of the buyer's “community,” or those that are available within a certain distance from the buyer's “community,” would be considered non-local items. A “non-local item” may also refer to an item that is not a “local item,” and vice versa.

According to an embodiment, the invention provides a Web-site having an item database and acting as a browsable/searchable catalog of items. Sellers visiting the Web-site may post items for sale. An entry in the item database is sometimes called a “posting” and the act of creating an entry in the item database is sometimes referred to as “posting an item.” The act of searching, retrieving and/or viewing information from the item database is sometimes called “browsing.”

In various places throughout the description, the term “community” refers to a group of people with similar needs or those who associate themselves with something that is common to all within the group. For example, college students may be considered a community, and college students attending Stanford University may be considered a community as well. Another example community may include military personnel working at a military facility and their families, as well as businesses and residents living in or around the military facility. Yet another example community may include the employees of a corporate entity and their families, as well as businesses and residents living in or around the corporate entity. These communities are not intended to represent an exhaustive list to which the invention pertains, but rather, they are merely examples of the types of potential communities within the scope of the present disclosure. The term “community” may also refer to the people living in particular area, the body of people in a learned occupation, or an association of people with similar interests.

As used herein, the term “community” also refers to an organization, entity or region with which a group of people is associated. For example, Stanford University, which is an entity with which students, faculty, staff and those living nearby are associated, is considered a community. An army base is considered a community, and a corporate campus is also considered a community. Cities and towns may be considered “communities” as well.

As used herein, the term “reach” refers to a number of interested parties a posting can generate. More specifically, an item's reach refers to a number of potentially interested buyers or sellers who will see the posting of the item. A posting is said to have “global reach” if it may generate a large number of interested viewers from a large number of areas. Other meanings of the above-mentioned terms may be implied by context.

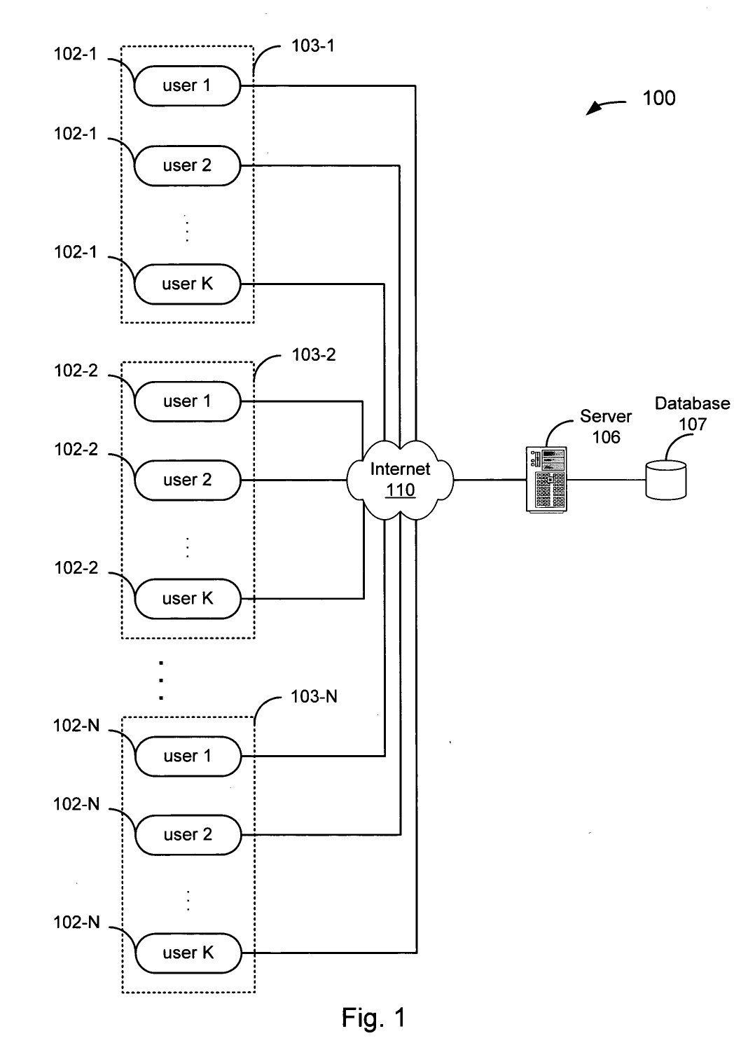

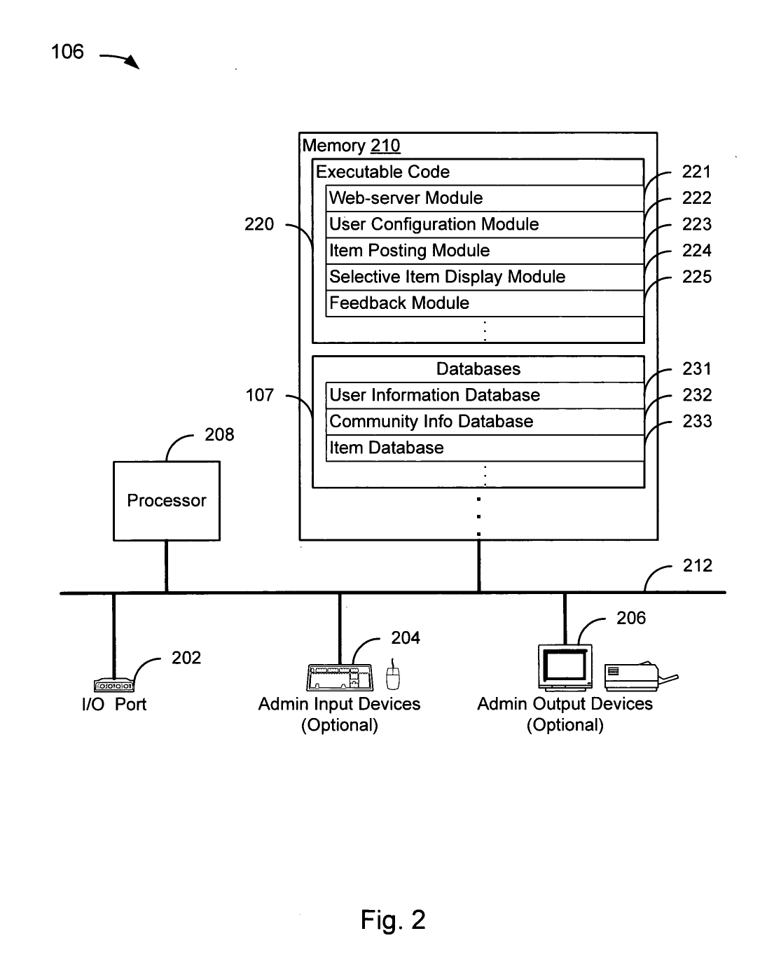

Referring now to FIG. 1, there is shown a business framework 100 on which embodiments of the invention may be practiced. The business framework 100 includes a server 106, which is accessible by users 102-1 to 102-N (collectively users 102) via a network 110, such as the Internet. The server 106 may host a database 107 on which the users can post items and in which users can browse and search the posted items. An example server 106 useful for this purpose is described in more detail with reference to an embodiment of the invention depicted in FIG. 2. Users may access the server 106 using many different types of Internet-enabled electronic devices, including computers, PDAs, and various wireless devices.

The users 102 are associated with communities 103-1 to 103-N, which are depicted as dashed boxes enclosing respective groups of the users 102. A community 103 may refer to a geographical area with which a group of people may be associated. For example, users 102-1 may be residents of Ames, Iowa, and the community 103-1 may correspond to the city of Ames, Iowa, itself. In some embodiments, a community 103 may refer to an organization or entity with which a group of people may be associated. For example, users 102-2 may be students of Iowa State University at Ames, Iowa, and the community 103-2 may correspond to the Iowa State University itself.

According to one embodiment of the invention, users within the same community may access, browse or search items posted by other users of the same community. For example, items posted by one of the users 102-1 may be viewable by other users of the same community 103-1. Users are able to access, browse or search items posted by users of other communities as well. However, items posted by users of other communities would be presented less prominently than the items posted by users of the same community. For example, local items may be listed before non-local items. As another example, when a user 102-N accesses the database 107, items posted by users 102-1 may be presented less prominently than items posted by another user 102-N of the same community 103-N. If one community is “near” another community, users in these communities may be able to view items posted by each other and items posted by users located in a far away community. In that case, the items posted by a user of a nearby community may be presented less prominently than items posted by another user of the same community, but more prominently than items posted by users of the far away community. Two communities may be considered “nearby” if they are separated by fifty miles, for example.

In one aspect, the invention may be used to target a specific group of people with similar needs or those who associate themselves with something that is common to all within the group. In one embodiment, the online marketplace allows a user to post an item on the online database and designate the item as related to a certain community of interest. For example, a book seller may post used college textbooks on the Web-site and designate the items as “local items” for a community comprising students of nearby colleges and universities. Such postings may be effective because they target a specific group of users precisely. Local buyers and sellers are benefitted since shipping costs may be avoided. At the same time, when the postings are targeted to a specific group, user experience may improve as users would be able to find more relevant items more easily.

It should be noted that a server 106 could host one or more databases. Alternatively, in addition to the server 106, another server could host additional databases. In yet another alternative, portions of the database could be hosted by one or more servers. Multiple databases may be hosted at a single (or co-located) hosting center(s) as well.

Referring now to FIG. 2, there is shown a server 106 for use with the business framework 100 of FIG. 1. The server 106 includes an input/output (I/O) port 202, admin input devices 204, admin output devices 206, a processor 208, a memory 210, and a bus 212 that connects the components. The memory 210 includes executable code 220 and databases 107. The I/O port 202 enables communication between the server 106 and a network, such as the Internet 110 (FIG. 1). The admin input devices 204 may include a keyboard, a mouse, or other input devices. The admin output devices 206 may include a monitor, a printer, or other output devices. The admin input devices 204 and admin output devices 206 provide monitor or update information to and from the server 106. The admin input devices 204 and admin output devices 206 are optional and may be remotely located. The processor 208 runs executable code 220 in the memory 210, which may include reading and writing data to databases 107. The processor 208 may include multiple processors. The processor 208 may be a central processing unit (CPU). The memory 210 may include dynamic or static random access memory (RAM) or other types of memory. The memory 210 may further include firmware components or magnetic or optical disk storage. Applications stored in the memory 210 may be developed on J2EE compliant application components.

The executable code 220 of the memory 210 includes a Web-server module 221, a user configuration module 222, an item posting module 223, a item presentation module 224, and a feedback module 225. The databases 107 of the memory 210 include a user information database 231, a community information database 232, and an item database 233. The Web-server module 221 includes code that allows the server 106 to respond to requests from a user, such as an Internet user, and to communicate with and respond to other modules and servers, if applicable. In some cases the Web-server module 221 provides an interactive interface such that the other modules may communicated with a client Web-browser program, such as Internet Explorer (TM).

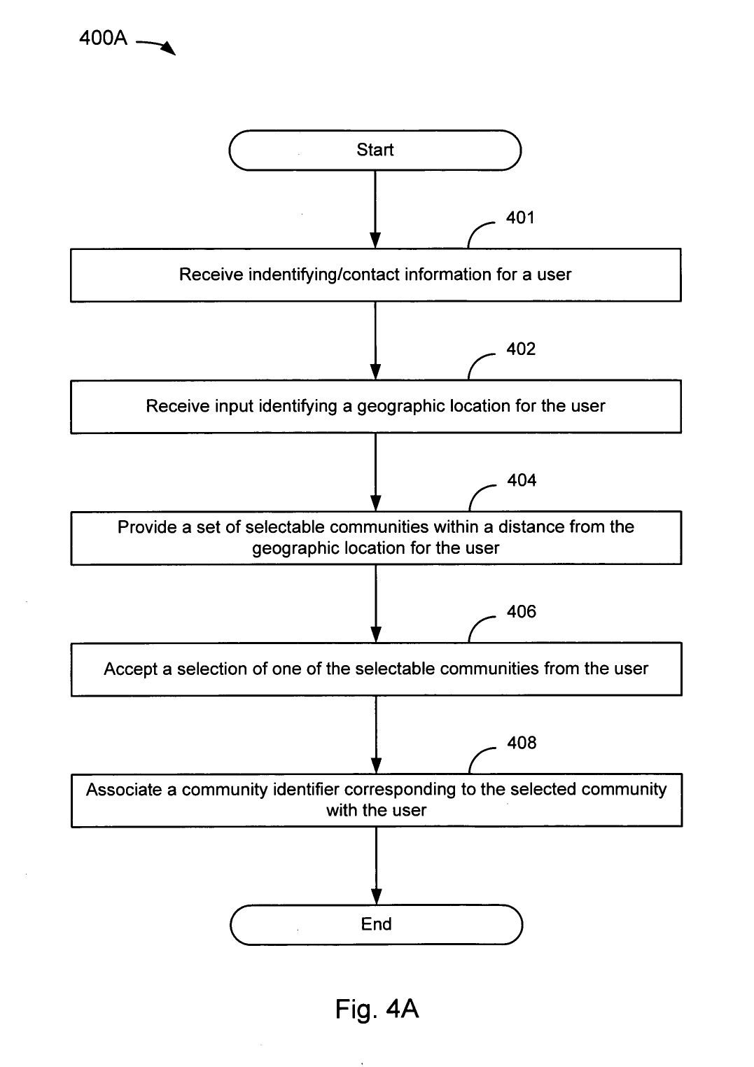

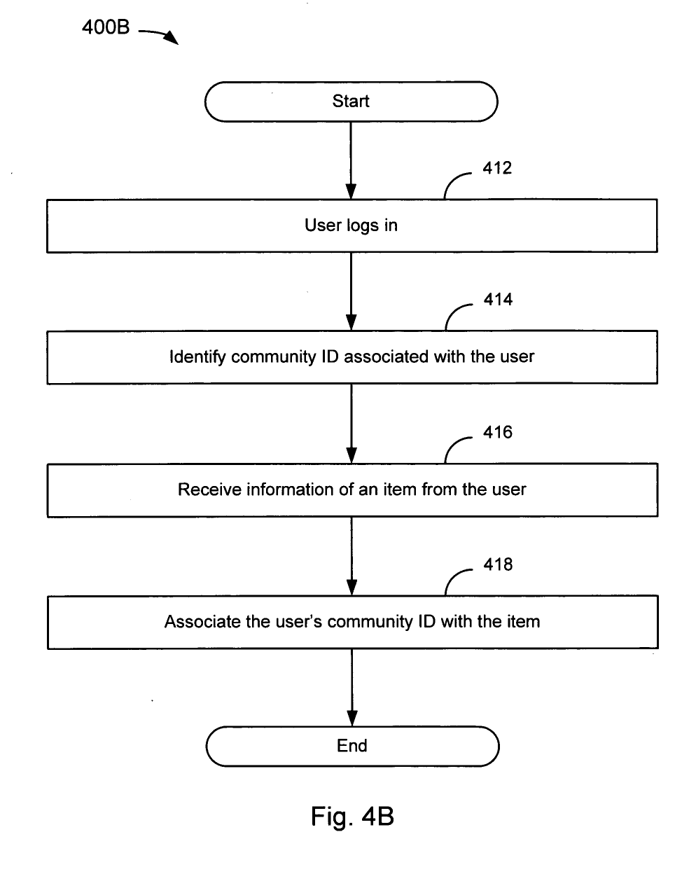

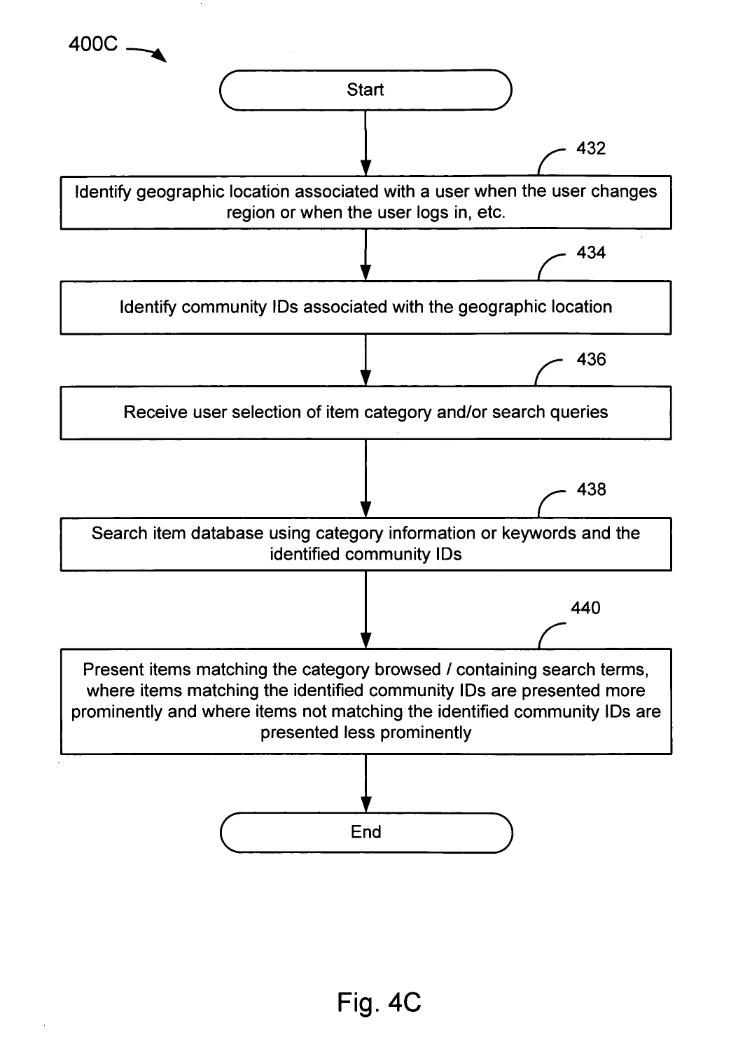

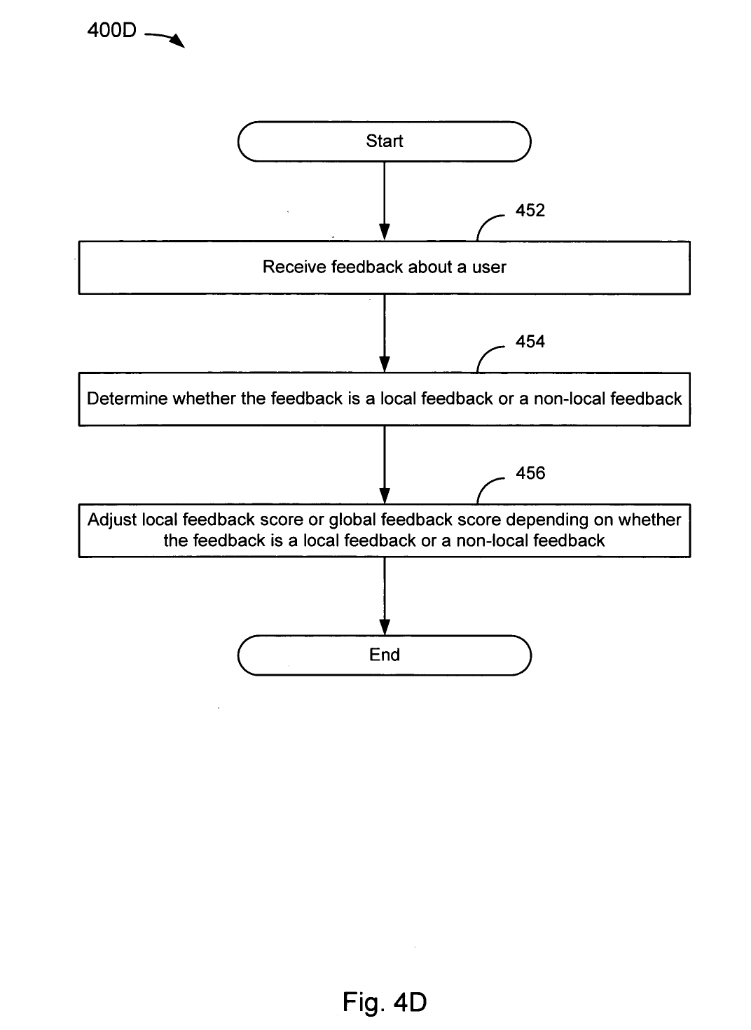

The user configuration module 222 includes code that allows the user to input or update user information in the user information database 231. In one embodiment of the invention, a user may need to register with the business framework 100 and create an account before they can post items for sale. When a user registers with the business framework 100, a user record for the user is added to the user information database 231. The user information database 231 is used to keep track of user information and activity. Furthermore, information of the user may be used to define its “home community.” For example, if the user indicates that his address is in Ames, Iowa, then his home community may be the city of Ames, Iowa, itself. And, if the user indicates that he is a student of or somehow related to Iowa State University, then his home community may be the Iowa State University itself. Users may have information entered on their behalf. For example, a university may create a user record for each new student. Note that users need not create an account before they can use the services provided by the business framework 100. For example, a user may not need to create an account in order to browse items posted by other users. That user may have to provide information regarding the location or community of interest, however. Additional functionality of the user configuration module is described later with reference to an embodiment of the invention depicted in FIG. 4A.

With reference still to FIG. 2, the item posting module 223 includes code that allows a user to create a posting to be stored in the item database 233, and code that allows the user to remove or delete a posting from the item database 233. In one embodiment, the item posting module 223 may request the user to define an item posting period after which the posting is automatically removed from the item database 233. Additional details of the item posting module 223 are described later with reference to an embodiment of the invention depicted in FIG. 4B.

With reference again to FIG. 2, the item presentation module 224 enables a user to access and view items stored in the item database 233. According to one embodiment, in response to the user's browsing and searching actions, the item presentation module 224 identifies the community with which the user is associated, and identifies items that are geographically relevant to the user (e.g., local items) and items that are not geographically relevant (e.g., non-local items). The item presentation module 224 may arrange the items in a certain order or groupings and pass the information to the Web server module 221. The Web server module 221 in turn may compile a Web-page that displays local items more prominently than non-local items. For example, multiple local items and non-local items may be displayed in the format of a list where local items would be displayed near the top of the list, followed by non-local items.

In one embodiment, the item presentation module 224 identifies the user's community by accessing the user information database 231. If the user is not registered, the item presentation module 224 may request the user to input a community of interest. Information that identifies the user's community may be stored as a “cookie” within the user's computer such that the user needs not re-enter the information every time he accesses the server 106.

According to an embodiment of the invention, the item presentation module 224 may include a browser engine that enables the users to browse selected categories of items stored on the item database 233. The item presentation module 224 further may include a search engine that enables the users to search for items using keywords, item types, item post dates, etc. In an embodiment of the invention that includes a search engine, the item presentation module 224 may return relevant items in a list, in which “local items” are ranked higher than “non-local” items even though the “non-local” items may be a better match for the user's search query. Additional details of the item presentation module 224 are described later with reference to an embodiment of the invention depicted in FIG. 4C.

With reference still to FIG. 2, the server 106 further includes a feedback module 225, which receives and provides feedbacks. According to an embodiment of the invention, each user may be associated to two or more feedback scores. One feedback score may be associated with feedbacks from “local” users (e.g., users from the same or nearby community), and another feedback score may be associated with feedbacks from both “local” and “non-local” users. Another feedback score for feedbacks from “non-local” users may be used as well. Further details of the feedback module are described later with reference to an embodiment of the invention depicted in FIG. 4D.

According to one embodiment of the invention, the server 106 may further provide an auction module (not shown) that allows users to auction their items. In that embodiment, an auction period may be defined, and at the end of the auction period, the potential buyer with the highest bid on the item will have “won” the item. Furthermore, at the end of the auction period, the item posting module 223 may remove the item from the item database 233 automatically.

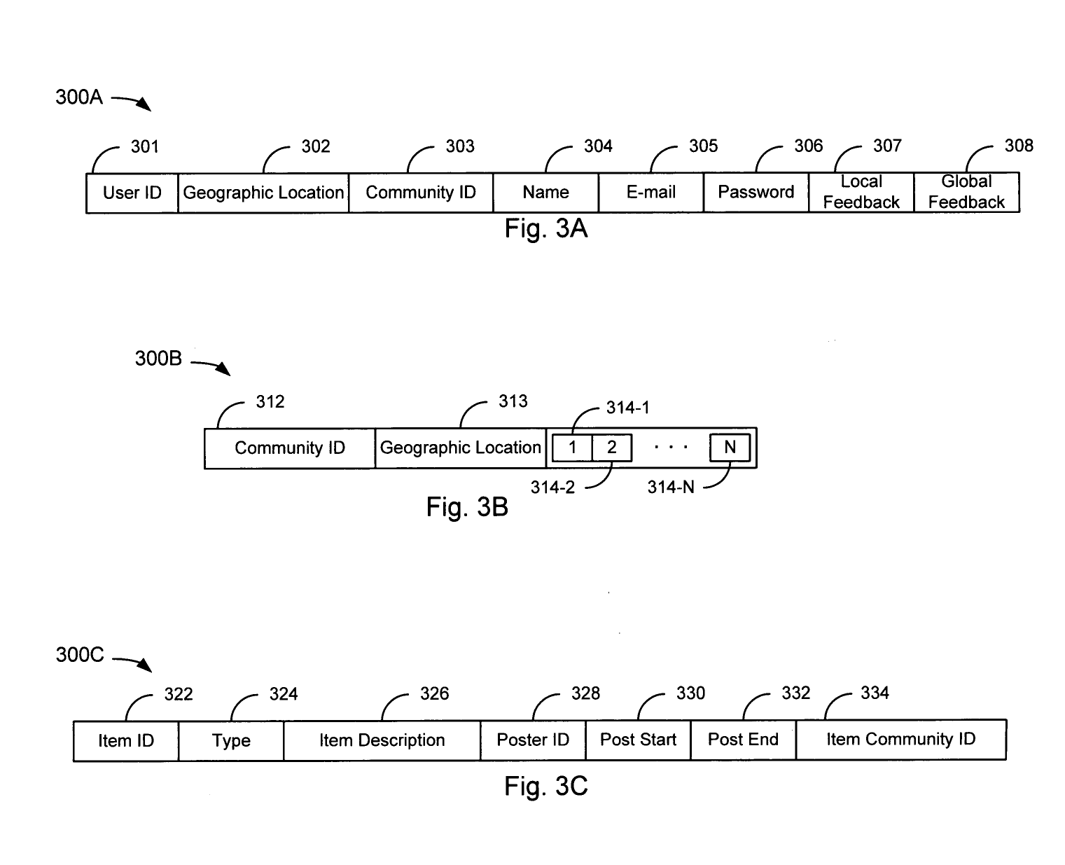

Attention now turns to FIGS. 3A-3C, which depict some example records in the user information database 231, community information database 232, and item database 233, respectively. The fields of the records are briefly described with reference to FIGS. 3A-3C, and then the use of these records is explained with reference to embodiments of the invention depicted in FIGS. 4A-4D.

FIG. 3A depicts an example user record 300A for use in the user information database 231 (FIG. 2). The user record 300A has multiple fields, including a user identifier (ID) field 301, an address field 302, a community ID field 303, a name field 304, an email field 305, a password field 306, a local feedback score field 307, and a global feedback score field 308. The user ID field 301 includes a unique identifier for the user. The geographic location field 302 includes the city, state, country, and zip code of the user's home, business, or other address. Alternatively, the geographic location may include only a phone number prefix (e.g., an area code), global position coordinates, or other geographic location identification data. The community ID field 303 identifies a community with which the user is associated. Each community may be represented by a unique community ID within the business framework 100. However, some communities may share the same community ID as well. The association of the user with the community is described later with reference to FIG. 4A. The name field 304 is for storing the user's name. The email field 305 is for storing the user's email address. The password field 306 is for storing a password for use with the user ID. The local feedback score field 307 and a global feedback score field 308 are for storing a local feedback score and a global feedback score, respectively. The feedback mechanism is described below with reference to FIG. 4D.

FIG. 3B depicts an example community information record 300B for use in the community information database 232 (FIG. 2), which stores data indicating whether one community is considered “near” another community. The community information record 300B has multiple fields, including a community ID field 312, a geographic location field 313, and a list of communities 314-1 to 314-N (hereinafter referred to collectively as local communities field 314). In one embodiment, the community information record 300B may be predefined by the operator of the business framework 100.

In one embodiment of the invention, the community information database 232 may be used by the user configuration module 222 to display a list of communities near an identified geographical location. For example, when a user provides a geographic location of interest, the user configuration module 222 may display a list of colleges and universities near the geographical location. Then, the user may be prompted to select a community from the list of colleges and universities, as will be described later with reference to an embodiment of the invention depicted in FIG. 4A.

FIG. 3C depicts an example item record 300C for use in the item database 233 (FIG. 2). The item record 300C has multiple fields, including an item ID field 322, an item type field 324, an item description field 326, a poster ID field 328, a post start field 330, a post end field 332, and an item community identifier field 334. The item ID field 322 uniquely identifies an item that is posted by a user, such as when the user offers an item for sale. The item type field 324 identifies the type of transaction sought, including, but not limited to, goods, services, personals, jobs, and real estate. The item type field 324 may include subtypes. For example, goods may be for sale (a first subtype), for rent (a second subtype), wanted for sale (a third subtype), or wanted for rent (a fourth subtype); services may be offered or wanted; jobs may be for openings or resumes, etc. Types may be further categorized. Each category or type has its own unique type ID. For example, goods may be categorized into books and sub-categorized into textbooks; services may be categorized into professional services and sub-categorized into legal services; and jobs may be categorized into full-time and sub-categorized into secretarial.

In some embodiments of the invention, the item type field 324 may be used to identify an item as a “featured” item. “Featured items” refer to items that are designed as such by the user, for example by paying a fee to the operator of the online marketplace. In one embodiment, featured items may be local items or non-local items. Furthermore, in one embodiment, featured local items may be listed first, followed by non-featured local items. Featured non-local items may be listed after the local items, and non-featured non-local items would be listed last.

In some embodiments of the invention, the item type field 324 may be used to identify an item as a “shippable” item or a “non-shippable” item. “Shippable items” refer to items that are designed as such by the user or by the online marketplace. Typically, items with low value-to-weight ratio are designated as non-shippable, and items with high value-to-weight ratio designated as shippable. In one embodiment of the invention, local items may be presented first regardless of whether they are shippable or not, followed by shippable non-local items, while non-shippable non-local items are not presented at all.

With reference still to FIG. 3C, the item description field 326 may include a title for display to potential buyers and a detailed description of the item for display to potential buyers who want more information about the item. The user posting the item may provide the item type and item description, as described later with reference to FIG. 4B. The poster ID field 328 identifies the user on whose behalf an item is presented. The poster ID field 328 may include a user ID that corresponds to a record in the user information database 231. The post start field 330 may contain a start date on which the item is listed, and the post end field 332 may contain an end date on which the item will be de-listed. The item record also has an item community ID field 334, which may contain the community identifier of the poster to indicate the community at which the item is available.

With some database records of the business framework having been described, attention now turns to FIGS. 4A-4D, which depict some operations of the software modules 220 and the databases 107. FIG. 4A depicts a flowchart 400A of a process of associating a user with a community. For illustrative purposes only, the flowchart 400A is described with reference to the Web-server module 221, the user configuration module 222, the user information database 231, and the community information database 232. Since the flowchart 400A depicts a method for configuring user information, the flowchart 400A is applicable when a new user registers with the business framework 100, or when a user updates his account information. In the case of a new user registering, additional steps (not shown) may be called for, such as verifying the new user's email address, etc. Additional steps may also include arranging for payment of membership dues, authenticating credit card information, or other membership-related steps. A benefit of registration is that a registered user may post items on the Web-site. It should be noted that the flowchart 400A is optional for users who do not wish to provide user information. Nevertheless, a user may have to provide at least a geographic location (e.g., by entering a zip code while browsing) to take advantage of features of the invention.

The flowchart 400A starts at block 401 with receiving identifying/contact information for a user. A user record 300A (FIG. 3A) may be added to the user information database 231 for the user. The identifying information may include a user identifier (user ID), which may be stored in the user ID field 301 of the user record 300A. In one embodiment, the user ID may be the email address of the user. In another embodiment, the user may be permitted to choose any user ID that is not in use by a current user. The identifying information may also include the user's name, which may be stored in the name field 304 of the user record 300A. Contact information may be in the form of an email address, which may be stored in the email field 306 of the user record 300A. The user may also provide or be provided a password for use with the user ID when logging in. The password is stored in the password field 305 of the user record 300A.

The flowchart 400A continues at block 402 with receiving input that identifies a general geographic location for the user. The user configuration module 222 may prompt the user to enter, for example, a city, state, country, and zip code, which are stored in the geographic location field of the user's record 300A (FIG. 3A) in the user information database 231. In an embodiment, the user needs only enter a zip code, or city and state. Alternatives may receive from the user information such as an area code or prefix of a telephone number, nearby local landmarks, GPS coordinates, latitude and longitude, and the like, as an indication of the general location of the user.

The flowchart 400A continues at block 404 with providing a set of selectable communities within a pre-defined distance from the geographic location provided by the user. Each user record 300A (FIG. 3A) of the user information database 231 includes the geographic location field 302 and each community record 300B (FIG. 3B) of the community information database 232 includes the geographic location field 313. The geographic location field 302 and the geographic location field 313 need not have the same format, but at least a portion of each field should be comparable. For example, the geographic location field 302 may include city, state, country, and zip code while the geographic location field 313 may include only a zip code. The zip code of the geographic location field 302 may be compared to the zip code of the geographic location field 313 to retrieve a list of local communities 314, such as a list of colleges and universities around that area. The Web-server module 221 may present the list as a set of selectable communities to the user so that the user can choose the nearby community with which he or she wishes to be associated.

As discussed earlier, the set of selectable communities may include entities with which a group of people may be associated and which are located within a pre-defined distance from the user's geographic location.

Referring once again to FIG. 4A, the flowchart 400A continues at block 406 with the user configuration module 222 accepting a selection of one of the selectable communities from the user.

The flowchart 400A ends at block 408 with associating the selected community with the user. According to one embodiment, if the list of selectable communities is empty, or if the user does not choose a community from the list, a community ID corresponding to the zip code of the geographic location field 302 may be stored in the community ID field 303. If the user chooses a community from the list, a community ID corresponding to the selected community may be stored in the community ID field 303. The user configuration module 222 stores the community ID for the selected community in the user's community ID field 303. In this way, the user becomes associated with the selected community. In some embodiments, the Web-server module 221 may store the community ID directly to the user information database 231 without invoking the user configuration module 222. According to an embodiment of the invention, all items posted by a user will automatically inherit the user's community ID, unless the user specifies otherwise.

FIG. 4B depicts a flowchart 400B of a process of posting items in the business framework 100 according to an embodiment of the invention. For illustrative purposes only, the flowchart 400B is described with reference to the Web-server module 221, the item posting module 223, the user information database 231, the community information database 232, and the item database 233. The flowchart 400B starts at block 412 with a user logging on to the business framework 100 and continues at block 414 with identifying the community information of the user. In one embodiment, the community information may be retrieved from the community ID field 303 of the user's record in the user information database 231. In one embodiment, a new user may be requested to set up an account with the business framework 100, an example process of which has been described with reference to FIG. 4A, before he can post an item.

The flowchart 400B continues at block 416 with receiving item information from the user. Item information may include a title (the portion of item description that is later displayed to potential buyers), description (the portion of the item description that provides more detailed information about the item), category, and other related information. The item may be represented in the item database 233 with an item record 300C (FIG. 3C). When item posting module 223 receives item information, it assigns the item an item ID, which may be stored in the item ID field 322 of the item's record 300C in the item database 233. The item received may also include (or otherwise be assigned) an item type (which may include a category), which may be stored in the item type field 324, and an item description, which may be stored in the item description field 326. The poster is identified in the poster ID field 328. The item may be given a timestamp, which may be stored in the post start field 330. The item may be assigned a date some pre-determined time in the future (e.g., one month after the post starts) as the expiration date of the post, which is stored in the post end field 332. The user may specify the post start date, post end date, or both.

The flowchart 400B continues at block 417 with receiving shipping instructions from the user. In one embodiment, the user may specify that the item is available only locally. The user also may specify that the item is available to non-local areas. If the user chooses to make the item available to non-local buyers, the user may further specify the shipment methods and payment methods, etc.

The flowchart 400B ends at block 418 with associating the user's community ID with the item. In one embodiment, the community ID of the user, which is identified at block 414 above, may be stored in the item community ID field 334.

According to one embodiment of the invention, the item's community ID may not be the same as the community ID of the user posting the item. In that embodiment, the user posting the item may select the community ID with which the item is associated. Furthermore, in that embodiment, an item may be associated with multiple community IDs.

According to one embodiment of the invention, the community IDs may be used to calculate the distance between the item's location (or seller's location) and the buyer's location. The distance in turns determines whether an item is local or non-local with respect to the buyer. In one embodiment, when the item is a local item, the item would be displayed more prominently than the non-local item, for example by listing the local items before the non-local items.

FIG. 4C depicts a flow chart 400C for a selective item display mechanism according to an embodiment of the invention. For illustrative purposes only, the flowchart 400C is described with reference to the Web-server module 221, the item presentation module 224, the user information database 231, the community information database 232, and the item database 233.

As shown, the flowchart 400C starts at block 432 with the Web-server module 221 identifying a geographic location associated with a user when the user initiates a session with the server 106 or changes region. In one embodiment, the user may have used the business framework before and may have a “cookie” stored on the user's device, and the “cookie” may indicate the user's community of interest during a previous session. In that case, the Web-server module 221 may retrieve such information from the “cookie” and may use such information in the current session. Alternatively, the user may be required to log on to his account, and/or the user may be prompted to enter a geographic location or a community of interest.

In one embodiment, when the user provides a geographic location (e.g., a zip code), the user may be presented with a list of selectable communities near the user's geographic location (e.g., a list of colleges and universities in or near the zip code) from which the user may choose as his community of interest.

The flowchart 400C continues at block 434 with the item presentation module 224 identifying one or more community IDs associated with the geographic location or community of interest of the user. In one embodiment, this step may be carried out by accessing information contained within the community information database 232. Typically multiple community IDs may be obtained. In one embodiment, community IDs of all communities located within a predetermined distance (e.g., fifty miles) of the user's community may be retrieved.

The flowchart 400C continues at block 436 with the item presentation module 224 receiving the user's selection of item category that he desires to browse, or the user's keywords if the user desires to use search engine functionality of the item presentation module 224.

The flow chart 400C continues at block 438 with the item presentation module 224 searching the item database 233 using the information received from the user and the community IDs identified in block 434 as search criteria. Preferably, all items meeting the search criteria are returned, and a ranking engine may be used to rank the relevancy of the search results.

The flow chart 400C ends at block 440 with the item presentation module 224 providing the search results to the Web server module 221, which communicates the search results to the user's computer device for display, for instance in the form of a Web-page. At the user's computer device, items matching the identified community IDs (e.g., local items) are presented more prominently than those not matching the identified community IDs (e.g., non-local items). The item's location may be displayed as well such that the user would know the location of the item. For instance, if the Web-page presents the search results in the form of a list, local items would be presented first, followed by non-local items. In another embodiment, local items are presented in a first section of the Web-page, and non-local items are presented in a second section, while the first list is presented more prominently, for instance in larger fonts. Many other ways of presenting some items more prominently than others should be apparent to those ordinarily skilled in the art having the benefit of this disclosure.

In an embodiment where the local items and non-local items are presented in the same list, the items may be ranked in terms of their distance from the buyer. Furthermore, in one embodiment, when an item is selected, delivery information is provided to the user. If the item is a local item, local delivery information, such as seller's address, may be displayed to the user. If the item is a non-local item, shipping information, such as mailing addresses of the seller, may be displayed to the user.

FIG. 4D depicts a flowchart 400D for a feedback mechanism according to an embodiment of the invention. After a transaction, the feedback module 225 may direct the Web-server module 221 to prompt the parties to a transaction for feedback. The feedback may be in the form of a “feedback score,” where one point will be given to the reviewee if the review is favorable, and where one point will be taken from the reviewee if the review is unfavorable. Note that, in one embodiment of the invention, the user may have a local feedback score and a global feedback score. A user's local feedback score reflects the feedback given by reviewers within the same or nearby communities, while the user's global feedback score reflects the feedback given by reviewers regardless of whether they are local or non-local to the reviewee. In one embodiment, the local feedback score and the global feedback score may be stored within a user record 300A (FIG. 3A) of the user information database 231 in their respective fields.

The flowchart 400D starts at block 452 with receiving feedback about a user. This feedback, for instance, may come from the buyer of an item. The feedback may come from a seller as well.

The flowchart 400D continues at block 454 with determining whether the feedback is a local feedback or a global feedback. The feedback module 225 checks the community ID field 306 of the user record of the reviewer, looks up the community ID field of the user record of the reviewee, and determines whether the reviewer and the reviewee are in the same or nearby community. In one embodiment, this step may involve the use of the community information database 232, which may contain the necessary information for such a determination.

The flowchart 400D ends at block 456 with adjusting the local feedback score or the global feedback score of the reviewee depending on whether the feedback is a “local” feedback or a “non-local” feedback.

Some sellers may be more accessible in closer communities than in those farther away. The disparity in quality of service based on the community wherein the transaction takes place may be an important consideration for some buyers. Moreover, feedback may make flooding positive feedback by allies (or negative feedback by enemies or competitors) more difficult because you must be a user of the community to provide feedback. Thus, community feedback may be more accurate than global feedback.

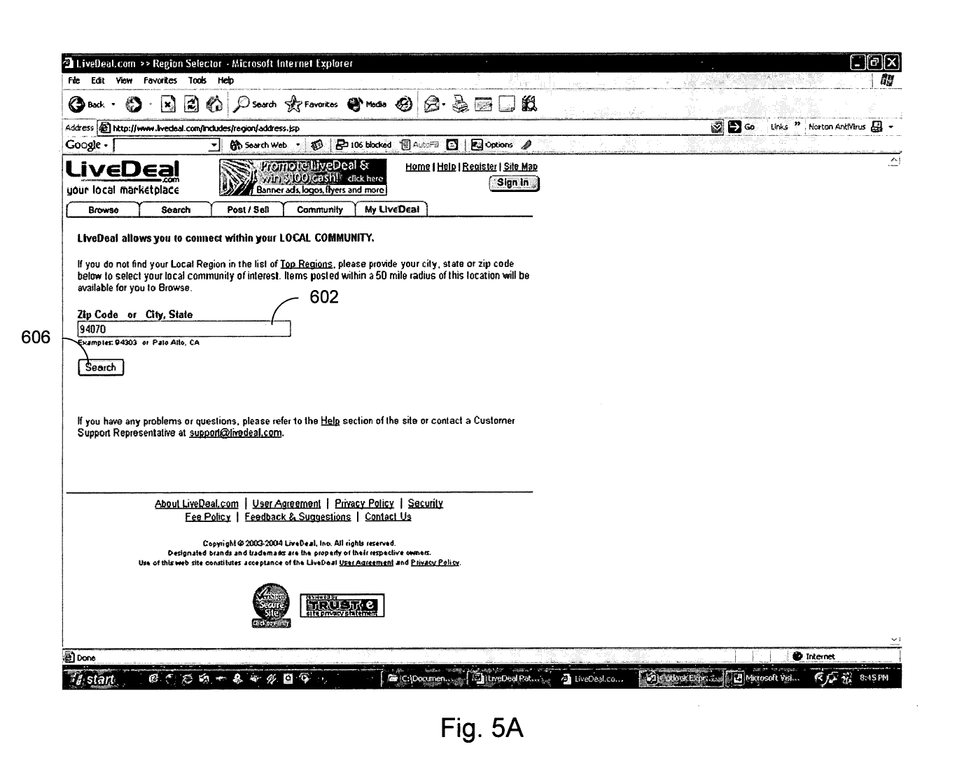

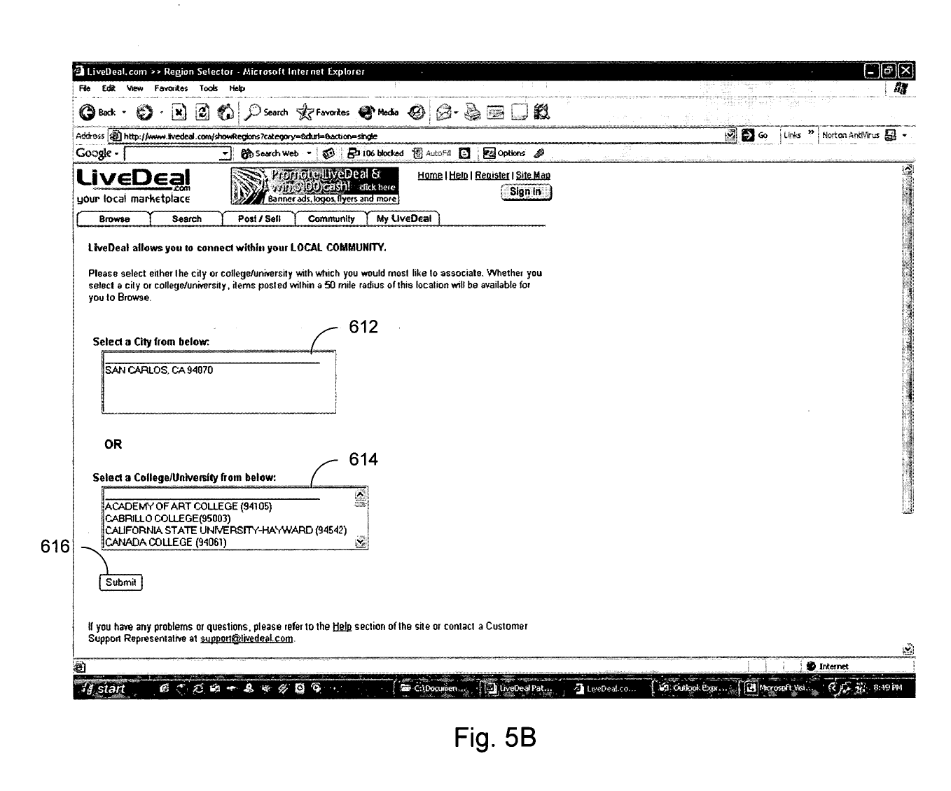

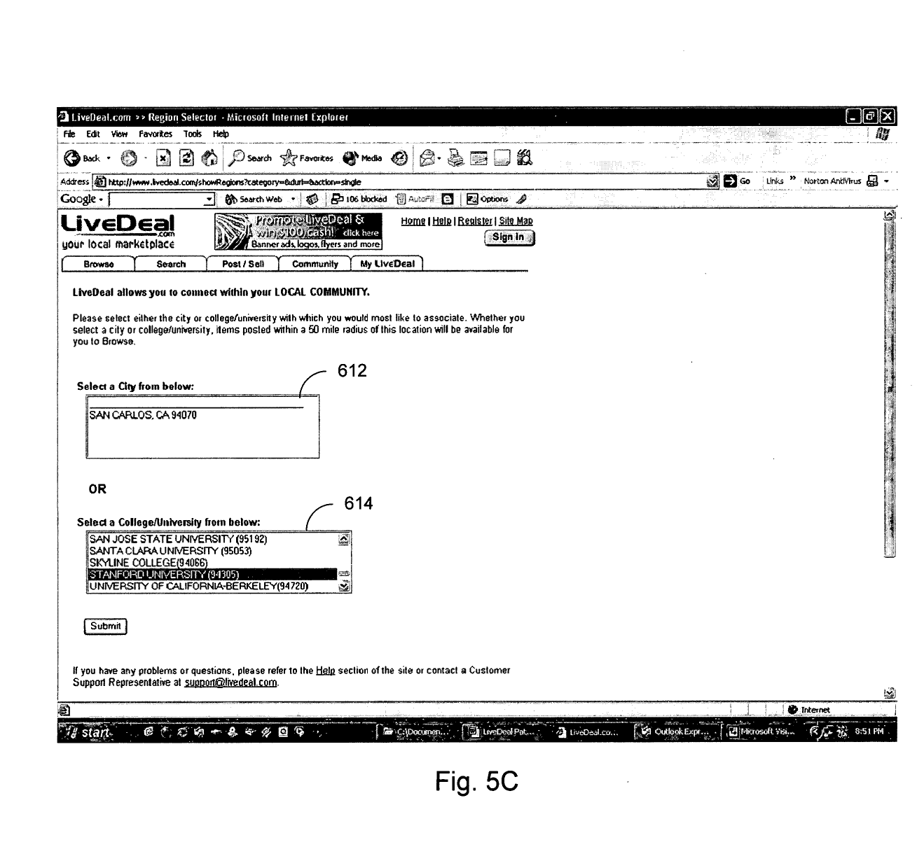

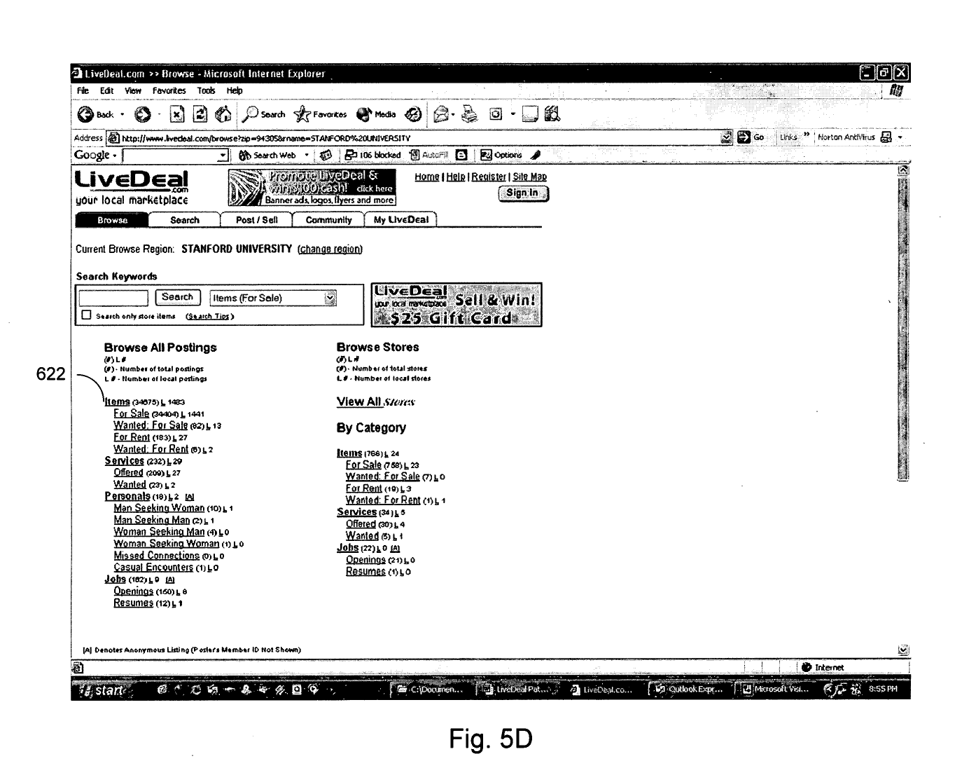

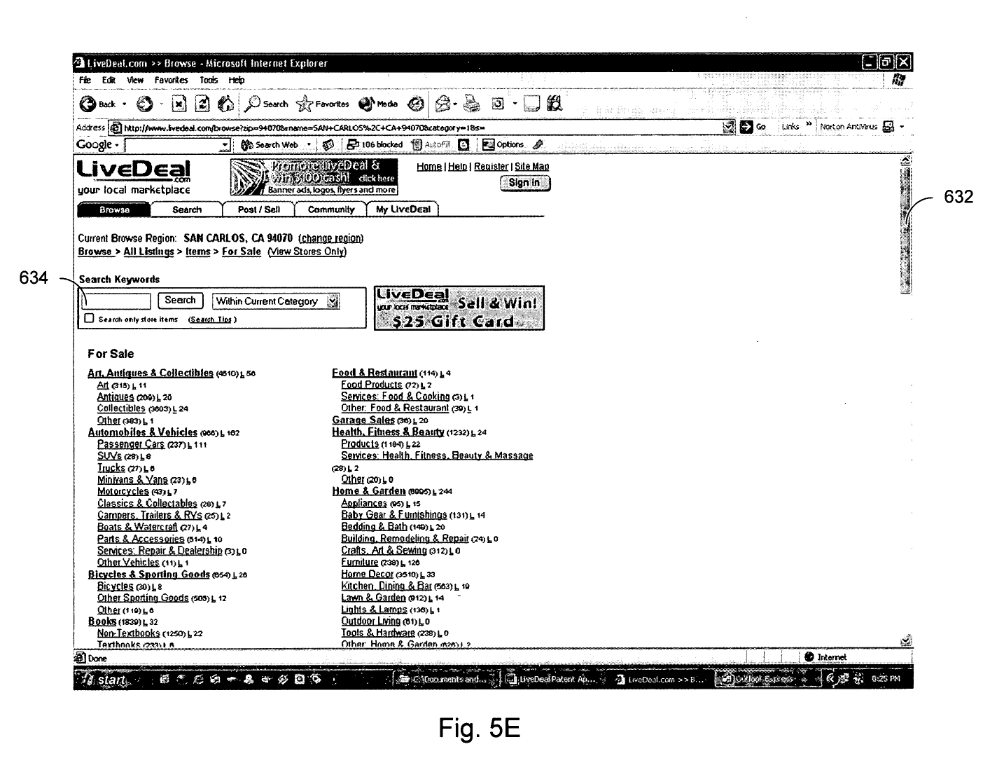

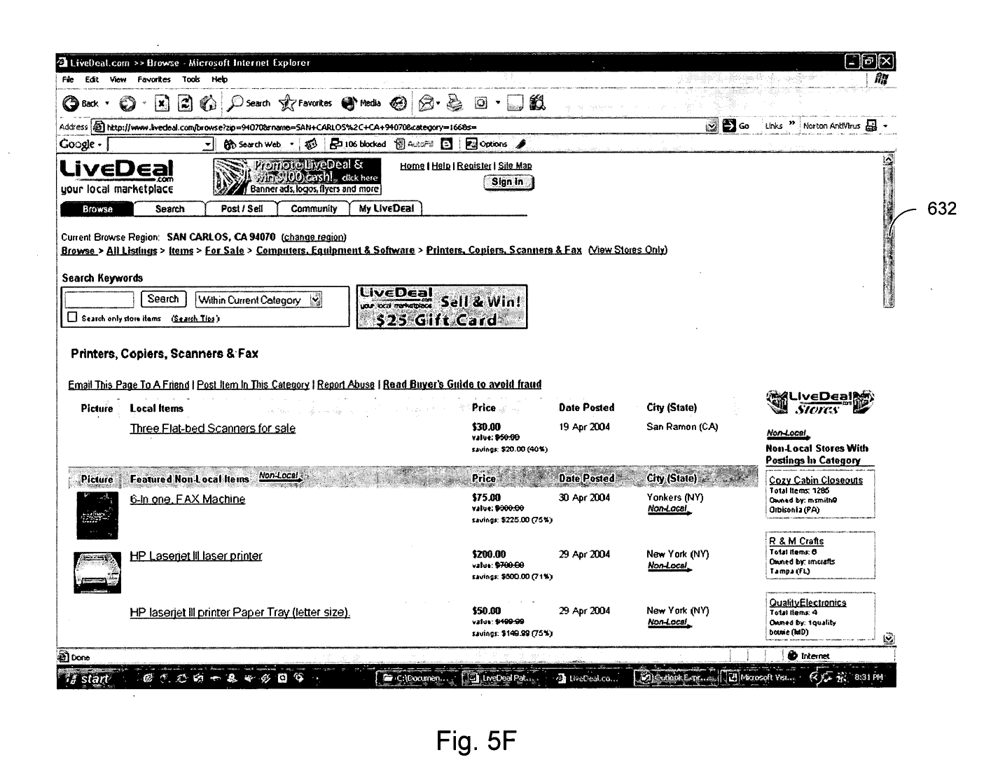

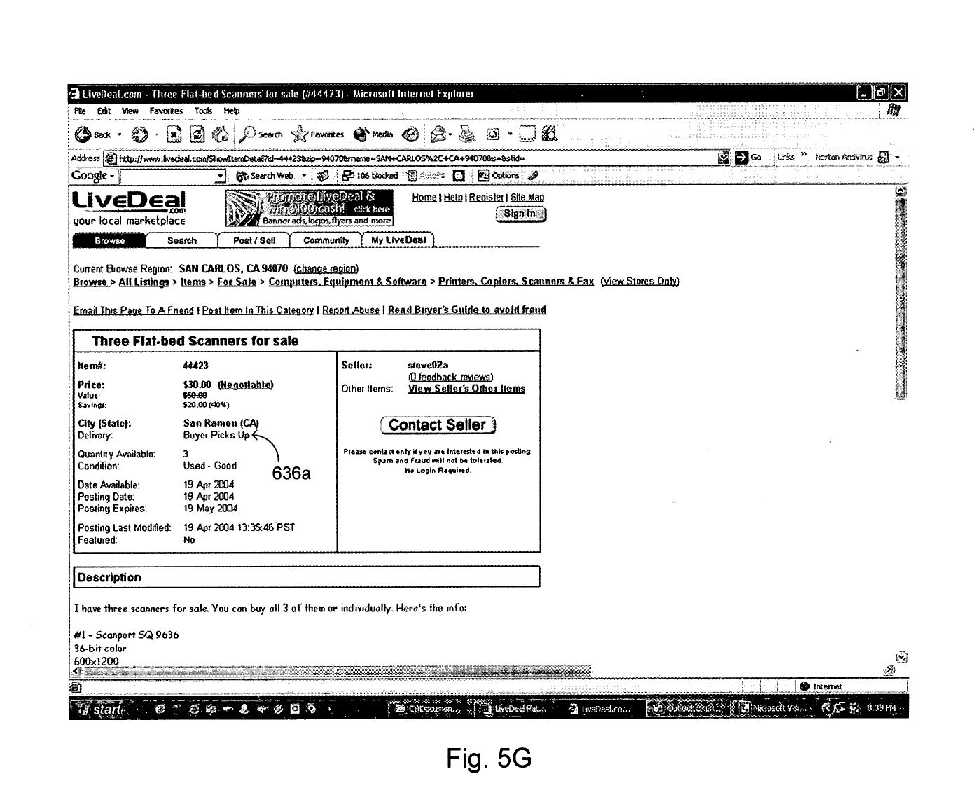

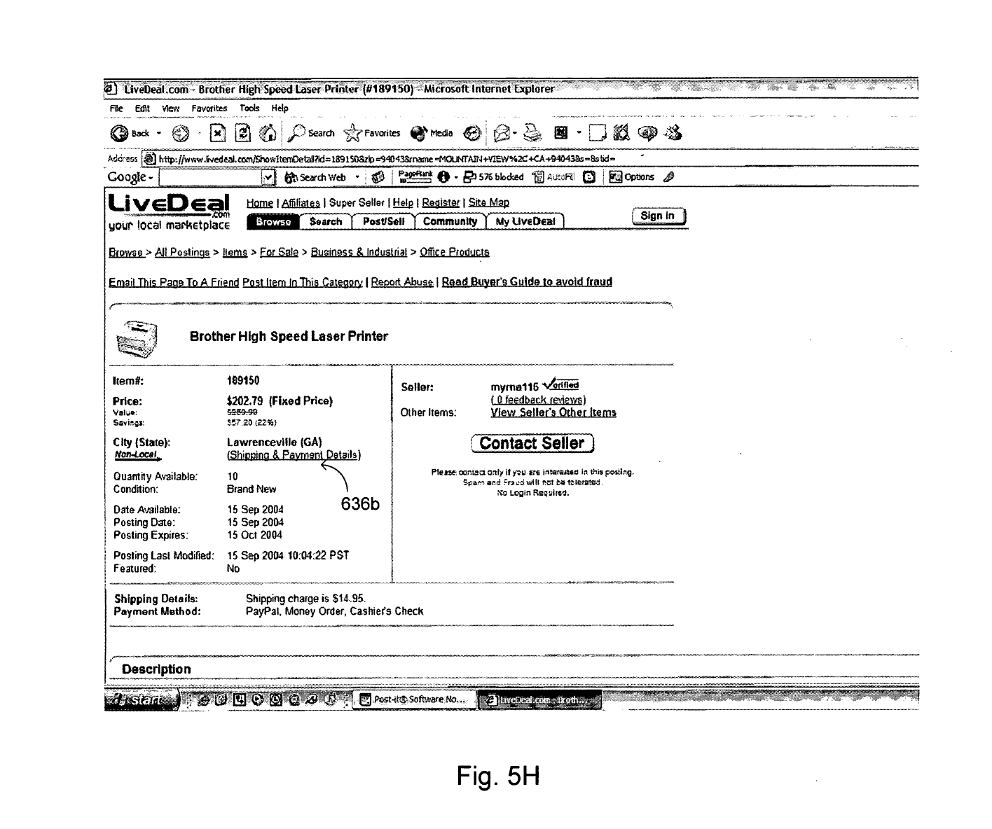

FIGS. 5A to 5H depict screenshots from a Web site according to an embodiment of the invention. The screenshots are intended to illustrate a Web experience for an Internet user who attempts to find a scanner for sale locally using the Web site.

FIG. 5A depicts a screenshot related to establishing the general location of a user. By establishing a general location, the system can determine which local communities are near the user's general location and provide a list of local communities from which to choose. In the example of FIG. 5A, the user is prompted to provide a zip code or city, state. For illustrative purposes, the user has entered the zip code “94070” in the text box 602. When the Internet user clicks on the search button 606, the screen depicted in FIG. 5B comes up.

FIG. 5B depicts a screenshot related to providing a set of selectable communities for the user. In one embodiment of the invention, the set of selectable communities are generated from the general location of the user. In the example of FIG. 5B, the user is given the option of selecting a city from the selectable list 612 or selecting a college or university from the selectable list 614. Note that the selectable list 612, in this example, includes only one entry, but it is nevertheless referred to as a list. When the Internet user selects a community to be associated with, the screen looks like, for example, the screenshot depicted in FIG. 5C.

FIG. 5C depicts a screenshot much like that of FIG. 5B where, for the purposes of example, Stanford University (94305) has been selected from the selectable list 614. The number in parenthesis is the zip code of the local community. After selecting a local community, when the user clicks on the submit button 616 the screen depicted in FIG. 5D comes up.

FIG. 5D depicts a screenshot related to browsing for items, services, personals, and jobs. In the example of FIG. 5D, the total numbers of global and local posts are displayed to the right of postings and categories. When the user clicks on, for example, Items For Sale 622, then the screen depicted in FIG. 5E comes up.

FIG. 5E depicts a category of different item types that are available on the online marketplace. On this page, a user may browse different categories of items by clicking on the relevant links, or enter a search keyword in the search box 634.

Note that in FIG. 5E, both the Total (Local and Non-Local) Item Count and Local Item Count are displayed for each category of available items, in the format described below in Table 1. According to an embodiment of the invention, the information displayed in such a format facilitates the browsing and searching of locally available items.

TABLE 1

For Browse:
(#) L#, where “(#)” denotes a number of total postings, and
“L#” denotes a number of local postings
For Search:
(#) L# S#, where “(#)” denotes a number of total postings,
and “L#” denotes a number of local postings, and “S#”
denotes a number of non-local postings

If the user scrolls down the page using the scrollbar 632 (or some other means, such as an arrow key or scroll wheel of a mouse) and selects for example “Printers, Copiers, Scanners & Fax” (not shown), then the screen depicted in FIG. 5F may come up.

FIG. 5F depicts a list of items that fall within the “Printers, Copiers, Scanners & Fax” category. Note that local items (e.g., “Three Flat-bed Scanners for Sale”) are presented first, followed by non-local Items. In the present embodiment, Featured Items are presented more prominently than other items. Users may designate their items to be Featured Items by payment of a fee to the operator of the online marketplace, for instance. Featured Items may be local items or non-local items, depending on the location of the buyer relative to the seller's.

Also note that the Web-page of FIG. 5F is divided into different sections with distinct headers to identify whether the item is local or no-local to the user. This distinction helps to facilitate easier, more efficient decision making for the use. If the user is price-conscious, he might choose the locally posted item instead of the one posted across the country to save on shipping costs. Also, the user may compare the prices of locally posted and non-locally posted items to make sure that the transaction price is aligned with local and non-local averages.

It should also be noted that in some cases the Web-page may include a long list of local items and non-local items. In that event, only local items would be displayed unless the user uses the scroll bar to display the lower-ranked local items and non-local items. In other cases the user may have to click on a Next Page link to view the lower-ranked local items and non-local items.

With reference still to FIG. 5F, if the user selects, for example, “Three Flat-bed Scanners for sale”, then an entry related to the selection is presented, such as is depicted in FIG. 5G. At this point, the user may consider contacting the party offering the item, or continue browsing for a different item.

Note that, in the Delivery Mode field 636a of FIG. 5G, the delivery mode “Buyer Pick Up” is displayed since the item is available locally to the buyer. Further information, such as seller's address may be provided to the buyer. If the item is not available locally to the buyer, a different delivery mode would be presented. For example, in FIG. 5H, the item is not available to the buyer. Thus, a link to a Web-page including shipping instructions is displayed in the Delivery Mode filed 636b. The shipping instructions may include the seller's mailing address, etc.

While the invention has been described and shown in connection with the preferred embodiments, it is to be understood that modifications may be made without departing from the spirit thereof. The embodiments described are by way of example and should not be construed as limiting of the claims except where referenced to the specification is required for such construction. For instance, it should also be understood that throughout this disclosure, where a software process or method is shown or described, the steps of the method may be performed in any order or simultaneously, unless it is clear from the context that one step depends on another being performed first. It should be understood by those skilled in the art upon reading the present disclosure that software processes, which have been described as client-side processes (e.g., those running on the presentation devices), can be performed as server-side processes (e.g., those running on a server), and vice versa, when appropriate. Elements of the invention may be implemented through computer program(s) operating on one or more general purpose computer systems or instruction execution systems such as personal computers or workstations, cable TV set-top boxes, satellite TV set-top boxes, computer gaming systems, video-phone systems, mobile systems (e.g., mobile computers, wireless telephones, personal digital assistants) or other microprocessor-based platforms. Furthermore, claims that do not contain the terms “means for” and “step for” are not intended to be construed under 35 U.S.C. § 112, paragraph 6.

1. A method of promoting geographically relevant transactions between buyers and sellers of an online marketplace, comprising:
receiving information from a user, the information indicating a community with which the user is associated, the information further indicating a search query provided by the user;
searching a database for items stored therein that match at least in part the search query;
based on the received information, identifying from the items that match at least in part the search query one or more items that are geographically relevant with respect to the user; and
generating an output to be displayed to the user, the output adapted to present the identified one or more geographically relevant items more prominently than one or more items that are less geographically relevant with respect to the user.

2. The method of claim 1, wherein the community corresponds to a geographical location.

3. The method of claim 1, wherein the community correspond to an entity with which a group of people are associated.

4. The method of claim 1, wherein the output comprises:
a first section to display the geographically relevant items; and
a second section to display items that are geographically less relevant with respect to the user.

5. The method of claim 1, wherein the output comprises a list in which the geographically relevant items are listed before the geographically less relevant items.

6. The method of claim 1, wherein the output is adapted to present location information of each of the geographically relevant items, and location information of each of the geographically less relevant items.

7. The method of claim 1, further comprising communicating the output to a computing device of the user to be displayed.

8. The method of claim 1, further comprising identifying from the items that match at least in part the search query one or more items that are designated as featured items.

9. The method of claim 8, wherein the output is adapted to present the featured items prominently.

10. The method of claim 8, wherein the output is adapted to present the featured items more prominently than the geographically relevant items.

11. The method of claim 1, wherein the output comprises local delivery information for at least one of the geographically relevant items.

12. The method of claim 1, wherein the output comprises shipping information for at least one of the geographically less relevant items.

13. A computer program product comprising a computer-readable medium having computer program instructions stored therein which are operable to cause a computer device perform a method of facilitating community-based and location-based transactions, the computer program instructions comprising:
computer program instructions to cause the computer system to receive information from a user, the information indicating a community with which the user is associated, the information further indicating a search query provided by the user;
computer program instructions to cause the computer system to search a database for items stored therein that match at least in part the search query;
computer program instructions to cause the computer system to identify, based on the received information and from the items that match at least in part the search query, one or more items that are geographically relevant with respect to the user; and
computer program instructions to cause the computer system to generate an output to be displayed to the user, the output adapted to present the identified one or more geographically relevant items more prominently than one or more items that are less geographically relevant with respect to the user.

14. The computer program product of claim 13, wherein the community corresponds to a geographical location.

15. The computer program product of claim 13, wherein the community correspond to an entity with which a group of people are associated.

16. The computer program product of claim 13, wherein the output comprises:
a first section to display the geographically relevant items; and
a second section to display items that are geographically less relevant with respect to the user.

17. The computer program product of claim 13, wherein the output comprises a list in which the geographically relevant items are listed before the geographically less relevant items.

18. The computer program product of claim 13, wherein the output is adapted to present location information of each of the geographically relevant items, and location information of each of the geographically less relevant items.

19. The computer program product of claim 13, further comprising computer program instructions to cause the computer system to communicate the output to a computing device of the user to be displayed.

20. The computer program product of claim 13, further comprising computer program instructions to cause the computer system to identify from the items that match at least in part the search query one or more items that are designated as featured items.

21. The method of claim 20, wherein the output is adapted to present the featured items prominently.

22. The method of claim 20, wherein the output is adapted to present the featured items more prominently than the geographically relevant items.

23. The computer program product of claim 13, wherein the output comprises local delivery information for at least one of the geographically relevant items.

24. The computer program product of claim 13, wherein the output comprises shipping information for at least one of the geographically less relevant items.

25. A method of promoting geographically relevant transactions between buyers and sellers of an online marketplace, comprising:
receiving information from a user, the information indicating a community with which the user is associated, the information further indicating a search query generated in response to an input by the user;
searching a database for items stored therein that match at least in part the search query;
based on the received information, identifying from the items that match at least in part the search query one or more items that are geographically relevant with respect to the user; and
generating an output to be displayed to the user, the output adapted to present the identified one or more geographically relevant items more prominently than one or more items that are less geographically relevant with respect to the user.
